(19) United States
(12) Patent Application Publication
(10) Pub. No.: US 2025/0208411 A1
(43) Pub. Date: Jun. 26, 2025

(54) METHOD AND DEVICE FOR COMPENSATING PHASE DISTORTION OF MULTIPLE WAVELENGTHS IN IMAGE WAVEGUIDES

(71) Applicant: Technische Universität Dresden, Dresden (DE)

(72) Inventors: Robert Kuschmierz, Dresden (DE); Jürgen Czarske, Dresden (DE); Elias Scharf, Dresden (DE); Jakob Dremel, Dresden (DE)

(73) Assignee: Technische Universität Dresden, Dresden (DE)

(21) Appl. No.: 18/932,219

(22) Filed: Oct. 30, 2024

(30) Foreign Application Priority Data
Dec. 22, 2023 (DE) 10 2023 136 560.6

(51) Int. Cl. G02B 27/00; G01M 11/02; G02B 26/06

(52) U.S. Cl. CPC G02B 27/0068; G01M 11/0207; G01M 11/0271; G02B 26/06

(57) ABSTRACT

The invention relates to a method and to a device for simultaneously compensating for the phase distortion of multiple wavelengths of an arrangement of electromagnetic waveguides and/or for implementing functions which change the propagation directions of electromagnetic radiation upon entrance into and/or exit from the arrangement, wherein these functions can be designed, for example, as focusing the electromagnetic radiation on a focal point, implementing a doughnut mode, and/or tilting the propagation direction of the electromagnetic radiation.

### CROSS REFERENCE TO RELATED APPLICATIONS

This application claims priority to German Application No. DE 10 2023 136 560.6, filed on Dec. 22, 2023, the entire contents of which are hereby incorporated by reference herein.

The invention relates to a method and to a device for compensating for the phase distortion of multiple wavelengths of an arrangement of electromagnetic waveguides, and/or for implementing functions which change the propagation directions of electromagnetic radiation upon entrance into and/or exit from the arrangement. The method may include changing the length of waveguides at one end of the arrangement and/or at the other end of the arrangement so that the end forms a phase mask, and/or providing and adding an element having a phase mask. The element is either a static element, which is provided by changing its surface properties, or an adaptive element which is provided by changing physical quantities such as voltages, currents, temperatures or pulse widths, so that it forms a phase mask. Possible areas of use of the method and device include, but are not limited to, microscopy, STED microscopy, confocal fluorescence microscopy, confocal imaging, nonlinear imaging, confocal autofluorescence microscopy, optical coherence tomography, spectroscopy, multispectral imaging, structured illumination, optogenetics, laser ablation, optical trapping, and/or endoscopy, multispectral endoscopy, and/or STED endoscopy.

### BACKGROUND OF THE INVENTION

Endoscopes for imaging and illumination are used in medical technology for minimally invasive diagnostics in difficult-to-access areas, which is why it is advisable to keep their diameter as small as possible (the target size is less than 0.5 mm) and their mechanical flexibility as high as possible. They also require a high contrast, a high spatial resolution and reliability, as well as suitable optical imaging modalities and low costs.

Multispectral imaging with high spatiotemporal resolution is required for tissue classification in cancer diagnostics based on machine learning, and for network analysis in optogenetics.

Multispectral information allows surgeons to better assess the health of tissue and differentiate between different fluids.

State-of-the-art borescope endoscopes are known which are based on rod and gradient index lenses (GRIN lenses—lenses in which the refractive index changes as a function of the distance from the center of the lens) and provide two-dimensional images of the intensity of electromagnetic radiation from the distal end (the application side) to the proximal end (the instrument side). Such endoscopes have, for functional reasons, rigid optical waveguide arrangements with diameters of more than 1 mm. This precludes applications in neurosurgery, for example.

In addition, the prior art includes camera endoscopes. These offer a high degree of flexibility because the camera and an illumination unit are located at the distal end, and only electrical signals need to be transmitted to the proximal end. The minimum endoscope diameter is 2 mm. Camera endoscopes likewise allow two-dimensional imaging—and no flexible lighting. Three-dimensional imaging is made possible by stereo camera systems, but requires a larger endoscope diameter of about 10 mm. Furthermore, the electromagnetic compatibility of camera endoscopes may be inadequate.

In nonlinear endomicroscopy, single-mode optical waveguides are usually used. Single-mode optical waveguides have only one spatial transmission channel, and for this reason require complex 2D/3D scanning optics at the distal end. This limits the minimum diameter to several millimeters. The scanning optics have a limited range of applications in terms of image field diameter and wavelength, and are associated with high costs. Conventional endoscopes have coherent bundles of optical waveguides—also known as coherent fiber bundles (CFB)—which contain about 10,000 to 100,000 fiber cores. An ordered fiber bundle is called “coherent” if the positional relationship between any two fibers of the bundle is maintained over the entire length of the bundle. Such endoscopes allow an undistorted transmission of the two-dimensional intensity distribution in the plane of the distal fiber end surface. Planes of the inspection region can be imaged by integrating rigid, macroscopic imaging optics on the distal fiber end surface. The relative spatial resolution is determined by the number of fiber cores. Distal imaging optics can increase the absolute spatial resolution, but reduce the diameter of the field of view. The minimum endoscope diameter is limited to the millimeter range by the necessary distal imaging optics.

CFB endoscopes without complex imaging optics in the distal measuring head would make possible an endoscope diameter of less than 500 μm, because it would only be limited by the fiber diameter. When a planar wave of electromagnetic radiation strikes one end of a CFB, the phase of the radiation may have a different phase as it exits each fiber at the other end of the CFB. This is due to the scattering due to the material parameters, such as the refractive index of individual fiber cores. Refractive indices are usually wavelength-dependent. The phase difference between the radiation exiting one fiber at the other end of the CFB and the phase of the exiting radiation averaged over all fibers is called phase distortion. Each CFB may have a different phase distortion, and for this reason the phase of the electromagnetic radiation cannot be determined. Only two-dimensional images with a fixed image plane are therefore possible. For high-resolution three-dimensional imaging, the most commonly investigated approach is to measure the phase distortion of the CFB and to compensate for it by means of a digital optical phase conjugation using programmable, digital, optical spatial light modulators (SLM). Spatial light modulators are adaptive elements that allow the phase modulation of electromagnetic radiation. For example, they may comprise arrangements of micromirrors that can be separately controlled, lowered raised and/or tilted. Spatial light modulators can also be embodied as liquid crystals on a silicon substrate—also known as liquid crystal on silicon (LCoS). By applying a voltage to individual crystals of an LCoS, their refractive index can be changed. LCoS can be designed to transmit and/or reflect electromagnetic radiation.

The publication WO 2005/065246 A2 discloses an illumination system comprising multimode optical waveguide bundles and a modulator, wherein the modulator can stretch the optical waveguides in order to reduce the spatial coherence of laser radiation and thus enable uniform illumination that is free of light granulation. The modulator can be a piezoelectric modulator. However, the device is disadvantageously not suitable for compensating for phase distortions of image waveguides simultaneously in multiple wavelengths. The disadvantage of multimode waveguides compared to single-mode waveguides is modal crosstalk.

U.S. Pat. No. 10,520,594 B2 describes a method and a system which make it possible to compensate for the phase distortion of an optical waveguide bundle for one wavelength at a time by detecting at the proximal end the observed phase distortion of light emitted by a virtual lodestar at the distal end of the optical waveguide bundle, and by subjecting light from an illumination source to the inverse of the observed phase distortion by means of a spatial light modulator before it enters the optical waveguide bundle and exits at the distal end without phase distortion. However, the method and system described does not have the advantage of reducing the phase distortion for multiple wavelengths simultaneously.

The publication EP 3 992 680 A1 describes a method and an arrangement which make possible an adapted illumination of an object with light. By positively, additively or subtractively arranging a flexible bundle of optical fibers, a phase mask is created on at least one of the fiber ends of the fiber bundle, which corrects the transmission distortions so that a coherent phase arrangement is available for imaging the object. The method and the arrangement make it possible to obtain three-dimensional information about an object by means of a flexible bundle of optical fibers without integrating imaging optics. The disadvantage of the method and arrangement is that the adapted illumination is not possible with multiple wavelengths simultaneously.

The publication WO 2013/144898 A2 relates to methods and a device for imaging with multimode optical waveguides, based on a wavefront-shaping system that compensates for the modal scrambling and the light dispersion through the multimode optical waveguide. After calibration of the multimode optical waveguide, a specific pattern is projected onto the proximal end of the waveguide to produce the desired illumination pattern at the distal end. The illumination pattern can only be scanned or dynamically changed by changing the phase pattern projected at the proximal end of the waveguide. The optical information generated by a sample is collected by the same waveguide in order to create an image. A disadvantage of the method and device is that they are not suitable for single-mode waveguides nor for simultaneous imaging in multiple wavelengths.

WO 2014/152474 A2 describes a system and method for imaging tissue and for image guidance in luminal anatomical structures and body cavities. Embodiments relate to optical waveguides having an additively or subtractively manufactured focusing optical lens at one end, in particular a GRIN lens, a refractive microlens or a diffractive lens. The disadvantage is that a lens is required at the distal end of the system, which increases its diameter. A disadvantage of the method is that only intensity information is transmitted, but no phase information and thus no depth information.

US 2018/0263470 A1 discloses an endoscope and an imaging unit, wherein the endoscope in embodiments has a convex shape at the proximal end of a fiber optic cable in order to focus light onto a sensor, and the convex shape can be created by an additive or a subtractive method. The disadvantage is that it is not intended to enable imaging in more than one wavelength or wavelength band, nor is it possible to compensate for phase distortions.

The publication CN 109445089 A discloses a device for three-dimensional imaging using multimode optical waveguides, as well as a method for high-speed wavefront modulation, comprising splitting a laser beam emitted by a laser into object light and reference light, performing phase modulation of the object light using a digital micromirror arrangement, and coupling the modulated object light into a multimode optical waveguide, capturing a pattern resulting from the interference of object light with the reference light, calculating a transmission matrix according to the interference pattern captured by the camera, loading a hologram onto a digital micromirror arrangement using a transmission matrix to modulate the incident light, coupling the incident light into a multimode optical waveguide and generating a focusing light spot or a three-dimensional point scan at an output end of the multimode optical waveguide, receiving light intensity information from reflected sample light or sample fluorescence through a photoelectric detector, recombining the light intensity information according to a fixed scanning sequence in order to obtain an image, and synthesizing in a three-dimensional direction in order to obtain a three-dimensional high-resolution image of the sample. A disadvantage is that the phase distortion cannot be compensated for in multiple wavelengths simultaneously.

The publication US 2022/0248938 A1 discloses an optical system and an imaging method. The optical system comprises a multifiber waveguide consisting of multiple optical waveguides and an optical diffuser that allows an intensity pattern to be projected onto the multifiber waveguide. The intensity pattern represents phase information of light emitted by at least one three-dimensional object. The waveguide is designed to transmit the intensity pattern in the form of a large number of pixels to an evaluation system. The evaluation system is designed to generate an image of the object, wherein the generation is based on the intensity pattern transmitted via the waveguide. The disadvantage is that the complex-valued transfer function of the system cannot be defined and the 3D imaging must be obtained exclusively from intensity information.

The publication US 2022/0019024 A1 describes a receiving device and a method for determining transmission properties of an optical waveguide. The receiving device has a waveguide interface for receiving a mixed light beam having a plurality of modes and a mixed shifted light beam from a multimode optical waveguide. The mixed and the mixed shifted light beams have an associated shifted phase for each mode. The receiving device also comprises at least one processor for determining mode information for the mixed light beam and shifted mode information for the mixed shifted light beam by using a trained neural network. Another purpose of the processor is to determine, for each mode, the respective associated phase by using the associated phase information of the light beam and the associated shifted phase information of the shifted light beam. The disadvantage is that the device and the method are not suitable for the simultaneous correction of phase distortions at multiple wavelengths, nor for single-mode waveguides.

The prior art provides possibilities for compensating for the phase distortion of waveguide arrangements for individual wavelengths, or sequentially for multiple wavelengths. The latter can be done, for example, with a spatial light modulator. However, this has the disadvantage that high temporal resolution is not possible. The prior art does not make it possible to compensate for the phase distortion simultaneously for multiple wavelengths. Furthermore, it is not clear from the prior art how functions can be implemented which change the propagation directions of electromagnetic radiation in qualitatively different ways upon entrance into and/or exit from the arrangement for multiple wavelengths.

### BRIEF SUMMARY OF THE INVENTION

The object of the invention is to overcome the disadvantages of the prior art and to provide a method and a device which allow compensating for the phase distortions in an arrangement of electromagnetic waveguides for multiple wavelengths simultaneously, and/or to implement functions that change the propagation directions of electromagnetic radiation upon entrance into and/or exit from the arrangement. It is also an object of the invention to implement different functions of this type for different wavelengths.

### BRIEF DESCRIPTION OF THE DRAWINGS

The invention is explained in more detail with reference to the drawings, wherein:

FIG. 1 is a schematic representation of electromagnetic radiation entering an arrangement (2) of electromagnetic waveguides (3) without phase distortion (1), and electromagnetic radiation (4) emerging from the arrangement (2) with phase distortions φ_{actual}

FIG. 2 shows the resulting phases φ_{res-red} (5), φ_{res-green} (6) and φ_{res-blue} (7) of an example of a waveguide of one embodiment of the method comprising a spatial light modulator (SLM) in the wavelengths 638 nm, 520 nm and 450 nm, and also the error function ƒ=\sqrt{Σᵢ₌₁³φᵣₑₛ_{ᵢ}²} (8), in each case as a function of the correcting variable xⱼ, wherein the correcting variable xⱼ in this embodiment is designed as an SLM grayscale value, and there is no implementation of an additional function φ_{add},

FIG. 3 is a schematic representation of electromagnetic radiation entering an arrangement (2) of electromagnetic waveguides (3) without phase distortion (1), wherein the arrangement has at one end an element (9) having an additively manufactured phase mask for compensating for the phase distortion φ_{actual} and for implementing an additional function φ_{add}, with the additional function φ_{add} being the focusing of the emerging electromagnetic radiation (10) onto a focal point,

FIG. 4 is a schematic representation of electromagnetic radiation entering an arrangement (2) of electromagnetic waveguides (3) without phase distortion (1), wherein the arrangement has at one end an element (11) having an additively manufactured phase mask for compensating for the phase distortion φ_{actual}, and of emerging electromagnetic radiation (12) whose phase distortion is compensated,

FIG. 5 is a schematic representation of electromagnetic radiation arriving at a spatial light modulator (SLM) without phase distortion (1), wherein the spatial light modulator (SLM) is adjusted such that the radiation (13) reflected by it has a phase shift φ_{shift}(λ,j)=((−φ_{actual}(λ, j))+φ_{add}(λ,j))mod (2π) which compensates for the phase distortion φ_{actual} of the radiation (12) when it exits an arrangement (2) of electromagnetic waveguides (3), wherein an additional function φ_{add} is implemented, with the additional function φ_{add} being the focusing of the emerging electromagnetic radiation (10) onto a focal point,

FIG. 6 is a schematic representation of a cross-section of an arrangement of electromagnetic waveguides (j),

FIG. 7 is a schematic representation of a cross-section of one end of an arrangement of electromagnetic waveguides, wherein the individual circles represent individual waveguides and their gray values are the values of the phase distortion φ_{actual}(λ₁,j) in one wavelength λ₁,

FIG. 8 is a schematic representation of a cross-section of one end of an arrangement of electromagnetic waveguides, where the individual circles represent individual waveguides and their gray values are the values of the phase distortion φ_{actual}(λ₂,j) in one wavelength λ₂,

FIG. 9 is a schematic representation of a cross-section of one end of an arrangement of electromagnetic waveguides, where the individual circles represent individual waveguides and their gray values are the values of the desired phase shift φ_{shift}(λ₁,j)=(−φ_{actual}(λ₁,j))mod (2π) in one wavelength λ₁,

FIG. 10 is a schematic representation of a cross-section of one end of an arrangement of electromagnetic waveguides, where the individual circles represent individual waveguides and their gray values are the values of the desired phase shift φ_{shift}(λ₂,j)=(−φ_{actual}(λ₂,j))mod (2π) in one wavelength λ₂,

FIG. 11 is a schematic representation of a cross-section of one end of an arrangement of electromagnetic waveguides, where the individual circles represent individual waveguides and their gray levels are the values of the desired modulated phase φ_{desired}(λ₁,j)=(λ_{actual}(λ₁,j)+λ_{shift}(λ₁,j))mod (2π) with phase shift φ_{shift}(λ₁,j)=(−φ_{actual}(λ₁,j)+φ_{add}(λ₁,j))mod (2π) in one wavelength λ₁, with the additional function φ_{add}(λ₁,j) corresponding to a focusing of electromagnetic radiation of the wavelength λ₁ onto a focal point,

FIG. 12 is a schematic representation of a cross-section of one end of an arrangement of electromagnetic waveguides, where the individual circles represent individual waveguides and their gray levels are the values of the desired modulated phase φ_{desired}(λ₂,j)=(φ_{actual}(λ₂,j)+φ_{shift}(λ₂,j))mod (2π) with phase shift φ_{shift}(λ₂,j)=(−λ_{actual}(λ₂,j)+φ_{add}(λ₂,j))mod (2π) in one wavelength λ₁, with the additional function φ_{add}(λ₂,j) corresponding to a donut mode of electromagnetic radiation of the wavelength λ₂,

FIG. 13 shows an intensity distribution of focused electromagnetic radiation of the wavelength λ₁ in the focal plane (BEF),

FIG. 14 shows an intensity distribution of focused electromagnetic radiation of the wavelength λ₁ in a plane in which the focal point lies, orthogonal to the focal plane (BEF),

FIG. 15 shows an intensity distribution of electromagnetic radiation of the wavelength λ₂ in a doughnut mode in the focal plane (BED),

FIG. 16 shows an intensity distribution of electromagnetic radiation of the wavelength λ₂ of a doughnut mode in a plane orthogonal to the focal plane (BED) on which the focal point lies,

FIG. 17 shows images in the wavelengths 450 nm, 520 nm, and 638 nm of a portion of a USAF resolution test panel illuminated with wavelengths of 450 nm, 520 nm, and 638 nm, respectively, by means of an optical waveguide arrangement. For illuminations in each of the three wavelengths, the USAF resolution test panel is imaged with a compensation of the phase distortion φᵢₛₜ optimized for each of the three wavelengths, as well as a compensation of the phase distortion in which the error function ƒ is minimized (RGB line), such that it is clear to the viewer that for the simultaneous imaging of the USAF resolution test panel with all waveguides of the arrangement in all three wavelengths the variant in which the error function ƒ is minimized is more suitable than the other three variants,

FIG. 18 shows an embodiment of the device which is designed for the method, for determining the phase distortion φ_{actual} of a CFB of the type Sumita HDIG, by means of off-axis holography using a Mach-Zehnder interferometer, such that the proximal end of the CFB is imaged onto a camera CAM1,

FIG. 19 shows an embodiment of the device, designed for the method, to image a USAF resolution test panel, wherein the aperture B1 blocks higher order diffraction.

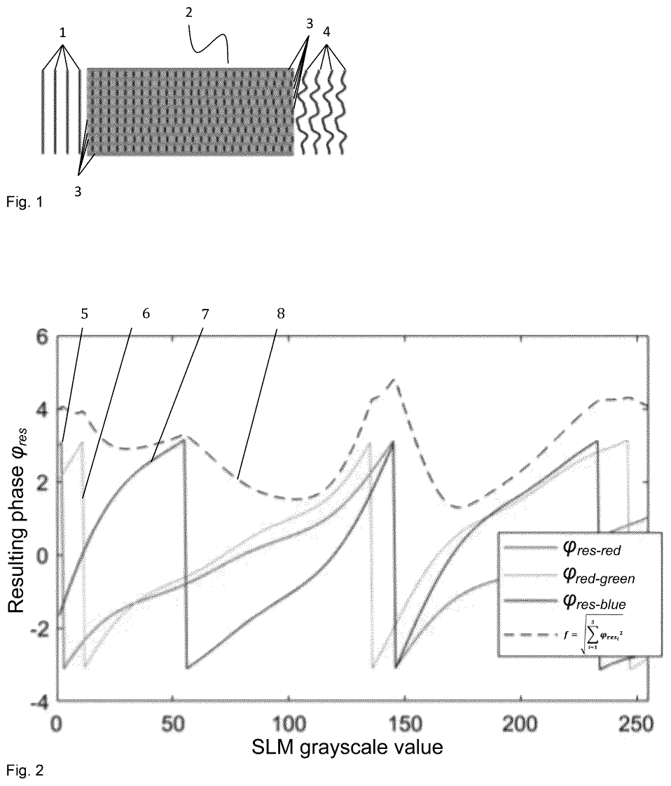

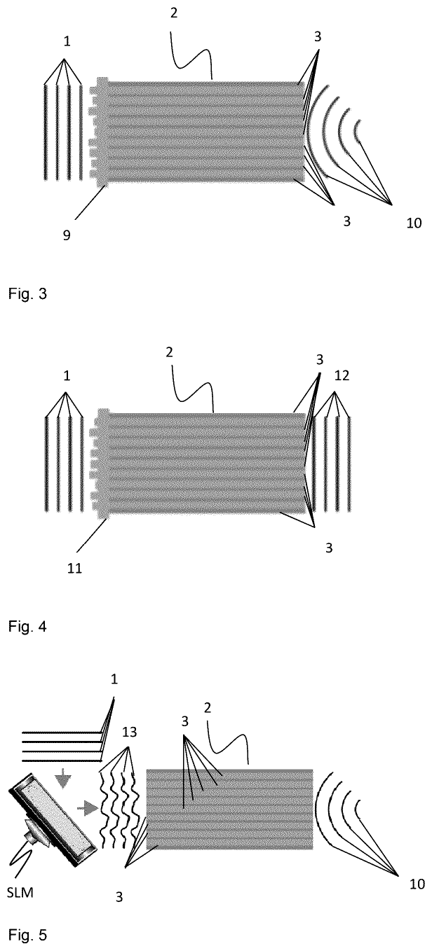

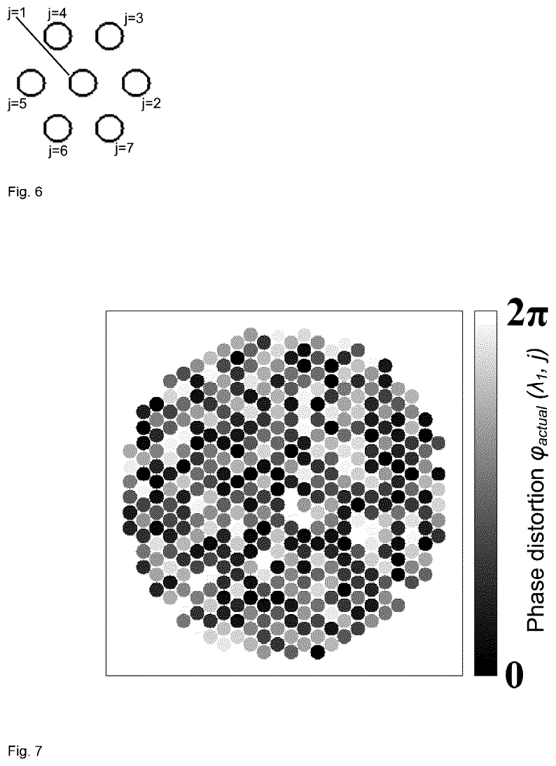

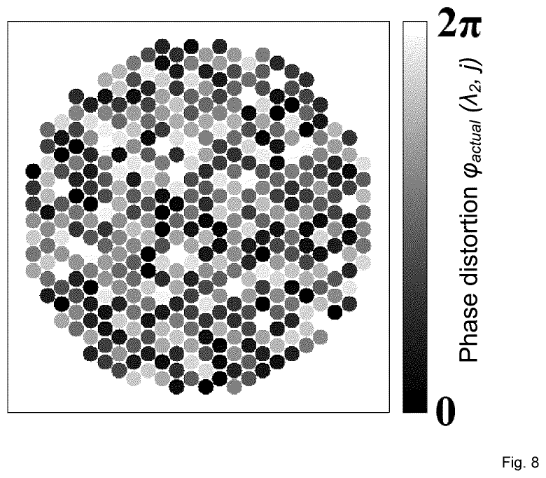

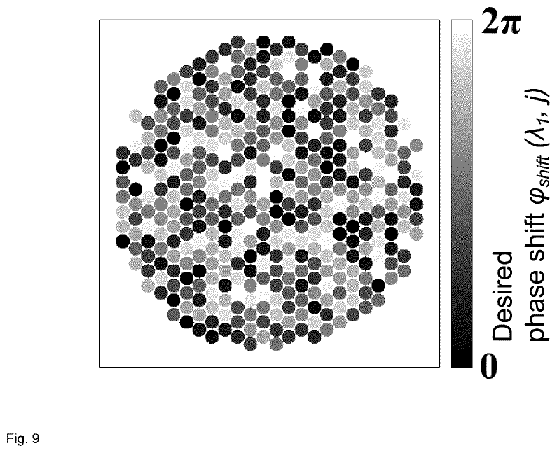

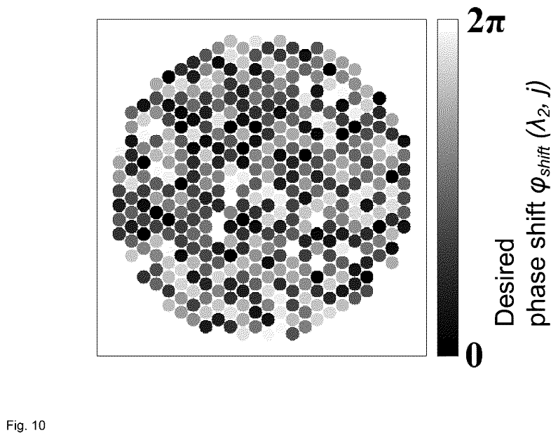

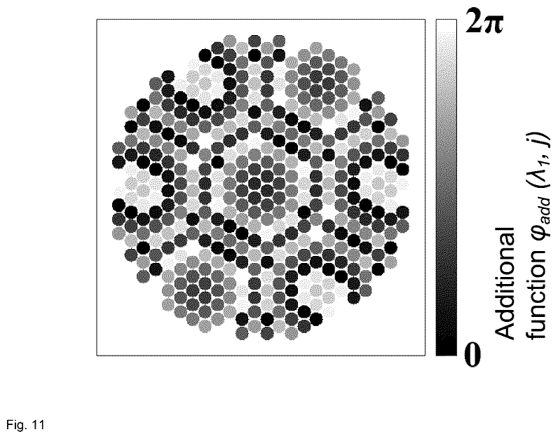

### DETAILED DESCRIPTION OF THE INVENTION

According to the invention, the object is achieved by a method having the features of claim 1, and by a device having the features of claim 13. Advantageous embodiments of the invention are provided in the dependent claims.

A first aspect of the invention relates to a method for compensating for phase distortions of at least two wavelengths in an arrangement of electromagnetic waveguides j and/or for implementing a function which changes the propagation directions of electromagnetic radiation upon entrance into and/or exit from the arrangement, comprising the steps of:
a) providing an arrangement of electromagnetic waveguides j, wherein the arrangement comprises at least two electromagnetic waveguides j,
b) modulating the electromagnetic phase distortion φ_{actual} of one or more selected waveguides j of the arrangement, said distortion having a functional relationship with a reference path length of one or more selected waveguides, for each of the wavelengths, comprising the sub-steps of:
i) measuring the electromagnetic phase distortion φ_{actual} for each of the wavelengths in each of the selected waveguides j,
ii) determining a desired modulated phase φ_{desired} for each of the selected waveguides j and for each of the wavelengths, wherein the desired modulated phase φ_{desired} for each of the wavelengths is determined independently or depending on φ_{desired} for one or more of the other wavelengths
iii) determining a functional relationship between a correcting variable xⱼ and a phase change φ_{corr} for each of the wavelengths and each of the selected waveguides j
iv) defining an error function ƒ to describe the total deviation between a resulting phase φᵣₑₛ=(φ_{actual}+φ_{corr})mod(2π) and the desired modulated phase φ_{desired} over all wavelengths for each of the selected waveguides j,
v) determining the value x_{j_ƒmin} of the correcting variable xⱼ for which the error function ƒ assumes a minimum value for each of the selected waveguides j.
vi)
1) providing and positioning an element for compensating for phase distortions of at least two wavelengths of an arrangement of electromagnetic waveguides and/or for implementing a function which changes propagation directions of electromagnetic radiation upon entrance into and/or exit from the arrangement, behind a first end and/or behind a second end of the arrangement, such that the element has the value x_{j_ƒmin} of the correcting variable xⱼ along the electromagnetic propagation direction of each of the selected waveguides, and/or
2) shortening and/or lengthening the selected waveguides to compensate for the phase distortion of the selected waveguides and/or to implement a function which changes the propagation directions of electromagnetic radiation upon entrance into and/or exit from the arrangement, at the first end and/or at the second end of the arrangement, such that the shortening and/or lengthening for each of the selected waveguides and each of the wavelengths has the value x_{j_ƒmin} of the correcting variable xⱼ,
such that the arrangement of electromagnetic waveguides comprising the element and/or the shortening and/or lengthening of the selected waveguides has a resulting phase φ_{res_ƒmin} for each of the wavelengths and for each of the selected waveguides, wherein the error function ƒ assumes a minimum value.

The electromagnetic radiation may include infrared radiation and/or visible light and/or ultraviolet radiation, but is not limited to the named regions of the electromagnetic spectrum.

The phase distortion φ_{actual} of a waveguide of the arrangement with index j at one wavelength λ can be calculated using the formula

$${φ}_{actual} ( λ , j ) = 2 π ( \frac{Δ L ( λ , j )}{λ} mod 1 ) ,$$

where ΔL is a deviation of an electromagnetic path length of the waveguide j at the wavelength λ from the average electromagnetic path length at the wavelength λ of all waveguides in the arrangement. The electromagnetic path length of the waveguide is the length of the path that electromagnetic radiation would travel in a vacuum in the same time that it takes to propagate through the waveguide into its rest frame.

Other descriptions of phase distortion φ_{actual} are not excluded. In an alternative embodiment, a reference path length can be used instead of ΔL—which is the deviation of the electromagnetic path length of a waveguide from an arbitrary reference length.

The desired modulated phase φ_{desired} can be set for each of the wavelengths independently or depending on the desired modulated phase φₛₒₗₗ for one or more of the other wavelengths, thus making it possible to implement different functions for different wavelengths. This means, for example, that for electromagnetic radiation of a first wavelength, a bundling of the radiation to a focal point is desired, while for radiation of a second wavelength, a doughnut mode is desired, and for radiation of a third wavelength a tilting of the propagation direction is desired. Combinations of such functions, such as tilting the propagation direction and focusing the radiation of one wavelength on a focal point, are also possible. It is also possible that φ_{desired} is selected for different wavelengths such that the propagation direction of the radiation is tilted by a different angle for each of the different wavelengths and/or is bundled at a different focal point for each of the different wavelengths. Examples of such functions are the focusing of the radiation to a focal point in a plane, similar to what is possible with a convex lens, the tilting of the radiation, or the generation of a doughnut mode, i.e. a ring-shaped distribution of the intensity of electromagnetic radiation in a plane.

In embodiments of the method, the desired modulated phase φ_{desired} can be described by the formula φ_{desired}(λ,j)=(φ_{actual}(λ,j)+φ_{shift}(λ,j))mod (2π), wherein φ_{shift}(λ,j) is a desired phase shift.

A change in the electromagnetic path length which results in the desired modulated phase φ_{desired}, can be calculated using the formula

$${L}_{desired} ( λ , j ) = \frac{λ {φ}_{shift} ( λ , j )}{2 π} + N λ$$

where N is any integer.

In further embodiments of the method, N lies in the region between and including −9 and +9

In embodiments of the method in which it is desired to compensate for the phase distortion φᵢₛₜ for one wavelength λ and one waveguide j and also to implement an additional function φ_{add}, the desired phase shift is determined φ_{shift}(λ,j) by the formula

$${φ}_{shift} ( λ , j ) = ( ( - {φ}_{actual} ( λ , j ) ) + {φ}_{add} ( λ , j ) ) mod ( 2 π )$$

In further embodiments of the method in which it is only desired to compensate for the phase distortion φ_{actual} for one wavelength λ and one waveguide j without implementing an additional function, the additional function φ_{add}(λ,j)=0 can be used, such that the desired phase shift is determined by the formula φ_{shift}(λ,j)=(−φ_{actual}(λ,j))mod (2π), and the phase distortion φ_{actual} is fully compensated for.

Since the correcting variable xⱼ in general cannot be varied for each wavelength individually, it is generally not possible to achieve the ideal state φ_{desired}=φᵣₑₛ for each wavelength and for each waveguide, which is why it is necessary to minimize the error function ƒ to get as close to the ideal state as possible.

In the context of the invention, a shortening and/or lengthening of the selected waveguides, even in cases where the error function ƒ for a waveguide already has the minimum value, can mean a shortening and/or lengthening of 0.

In embodiments, the error function ƒ can be determined
by taking a square root of the squares of the deviation between the resulting phase φᵣₑₛ and the desired modulated phase φ_{desired} summed over all wavelengths, or
by summing over all the wavelengths the absolute values of the deviation between the resulting phase φᵣₑₛ and the desired modulated phase φ_{desired},
for each of the selected waveguides.

The error function ƒ can be determined by the formula

$$f = \sqrt{{\sum }_{i = 1}^{i \geq 2} {( ( {φ}_{{res}_{i}} - {φ}_{{desired}_{i}} ) mod ( 2 π ) )}^{2}}$$

or by means of the formula

$$f = {\sum }_{i = 1}^{i \geq 2} \vert ( {φ}_{{res}_{i}} - {φ}_{{desired}_{i}} ) mod ( 2 π ) \vert$$

In this case, i is an index of one of the wavelengths, φ_{desired}_{ᵢ} and φᵣₑₛ_{ᵢ} are in each case the desired modulated phase and the resulting phase for the wavelength with index i, and the expression i≥2 represents the number of the at least two wavelengths.

In embodiments, the resulting value of the correcting variable x_{j_ƒmin} for each of the selected waveguides is determined by an iterative method, such that the iterative method minimizes the error function ƒ.

An advantage of iterative methods over computational methods is that the former are robust in relation to model errors, whereas the precision of computational methods is limited by the accuracy of the mathematical models on which they are based.

In embodiments of the method, the resulting value of the correcting variable x_{j-ƒmin} is determined for each of the selected waveguides by an iterative method comprising the steps of:
a) measuring, in a plane behind the first end or behind the second end of the arrangement or of the arrangement comprising the element, the intensity of electromagnetic radiation guided through each of the selected waveguides in each of the wavelengths,
b) determining the difference between the measured intensity and the expected intensity for the desired modulated phase φ_{desired}, for each of the wavelengths and each of the selected waveguides,
c) changing the value of the correcting variable xⱼ for each of the selected waveguides,
d) carrying out steps a), b) and c) until a local minimum or the global minimum of the difference between the measured intensity and the expected intensity with the desired modulated phase φ_{des}ir_{ed} is determined, and setting the correcting variable xⱼ to the value at which the determined local minimum or global minimum is reached, for each of the selected waveguides.

In embodiments of the method, the correcting variable xⱼ has a functional relationship with
a) a path length difference ΔSⱼ and/or
b) a voltage Uⱼ and/or
c) an electrical current Iⱼ and/or
d) a current pulse width Pᵢⱼ and/or
e) a voltage pulse width P_{Uj} and/or
f) a temperature Tⱼ and/or
g) an SLM grayscale value.

The correcting variable xⱼ can be adjusted by using different methods.

In embodiments, if it is adjusted by means of a shortening and/or lengthening of the selected waveguides, the correcting variable xⱼ has a functional relationship with a path length difference ΔSⱼ caused by shortening and/or lengthening. The correcting variable xⱼ also has a functional relationship with a path length difference ΔSⱼ if it is adjusted by means of an additive or ablative manufacturing of a transmissive element.

In further embodiments, if the correcting variable xⱼ is adjusted by means of a spatial light modulator, it can have a functional relationship with one or more physical quantities with which the spatial light modulator is controlled. This quantity or quantities can be a voltage Uⱼ and/or an electrical current Iⱼ and/or a current pulse width Pᵢⱼ and/or a voltage pulse width P_{Uj} and/or a temperature Tⱼ. This quantity or quantities can also have a functional relationship with a path length difference ΔSⱼ. This is the case, for example, if a spatial light modulator has an arrangement of micromirrors that can be separately controlled, lowered, raised and/or tilted.

The correcting variable xⱼ can be controlled by current or voltage pulse width modulation in embodiments with spatial light modulators.

The correcting variable xⱼ can be controlled in further embodiments with spatial light modulators by temperature modulation, wherein the temperature is functionally related to a current and/or a voltage. Thermo-optically modulated spatial light modulators, for example, can be controlled by temperature, which in turn can be controlled by an electrical current.

In embodiments, each element of a spatial light modulator can assume grayscale values in the range from 0 to 255.

The phase change φ_{corr} of a waveguide of the arrangement with subscript j at one wavelength Δ can be calculated using the formula

$${φ}_{corr} ( λ , j ) = \frac{{x}_{j} ( n ( λ , j ) - {n}_{U} ( λ ) )}{λ}$$

mod (2π), where n(λ,j) is the refractive index of the waveguide j at the wavelength Δ for the material to which the correcting variable xⱼ is applied, and n_{U}(λ) is the refractive index of the medium surrounding the arrangement at the wavelength λ.

Other descriptions of the phase change φ_{corr} are not excluded.

In general, different values of the correcting variable xⱼ can have the same phase change φ_{corr} for one wavelength. This principle makes use of the method according to the invention to determine a value of the correcting variable xⱼ at which the resulting phase φᵣₑₛ=(φ_{actual}+φ_{corr})mod(2π) corresponds to the desired modulated phase φ_{desired} for all of the wavelengths as closely as possible. Surprisingly, this is the case with values of the correcting variable xⱼ for which the phase change φ_{corr} would be far beyond 2π if it did not comprise the modulo-operator mod(2π).

In embodiments of the method, the functional relationships between the correcting variable xⱼ and the quantities mentioned in a) to f) are each determined by a calibration, and/or the functional relationship between the correcting variable xⱼ and the path length change ΔSⱼ comprises the difference—normalized for the corresponding wavelength—between
a) the refractive index of the lengthened and/or shortened waveguides and/or of the element, and
b) the refractive index of the medium surrounding the arrangement.

If the correcting variable xⱼ is adjusted by a spatial light modulator comprising a micromirror arrangement, the phase change φ_{corr} can be described for example by

$${φ}_{corr} ( λ , j ) = 2 π ( \frac{{x}_{j}}{λ} mod 1 ) ,$$

wherein the correcting variable xⱼ with the path length difference ΔSⱼ comprises the functional relationship xⱼ=n_{U}(λ)ΔSⱼ. Here

$$\frac{{x}_{j}}{λ}$$

can contain values between and including −9 and +9.

If the correcting variable xⱼ is adjusted by shortening and/or lengthening the selected waveguides and/or by a transmissive element, the phase change φₛₜₑₗₗ can be described for example by

$${φ}_{corr} ( λ , j ) = 2 π ( \frac{{x}_{j}}{λ} mod 1 ) ,$$

wherein the correcting variable xⱼ with the path length difference ΔSⱼ comprises the functional relationship xⱼ=((n(λ,j)−n_{U}(λ))ΔSⱼ. Here

$$\frac{{x}_{j}}{λ}$$

can contain values between and including −9 and +9.

In embodiments of the method, the at least two wavelengths are in a wavelength range from 100 nm to 1,000,000 nm, advantageously in a wavelength range from 100 nm to 3,000 nm, particularly advantageously in a wavelength range from 350 nm to 1,550 nm and/or are selected from the wavelengths 450 nm, 520 nm, 530 nm, 620 nm, 630 nm, 638 nm, 920 nm, 1,330 nm and 1,550 nm.

In embodiments, the at least two wavelengths lie in a range of the electromagnetic spectrum ranging from UV-C to FIR radiation.

In embodiments, the at least two wavelengths are in a region of the electromagnetic spectrum ranging from UV-C to IR-B radiation.

In embodiments, the at least two wavelengths are in a range of the electromagnetic spectrum ranging from and including UV-C through the range of IR-A radiation to the shortest-wavelength

$$\frac{3}{32} nd$$

of IR-B radiation.

In embodiments of the method, the arrangement of electromagnetic waveguides is designed as an image waveguide and/or as a bundle of optical fibers comprising at least two optical waveguides and/or as a bundle of optical fibers comprising 100 to 100,000 optical waveguides.

In embodiments of the method, the arrangement of electromagnetic waveguides is designed as a bundle of single-mode optical waveguides.

In embodiments, the arrangement of electromagnetic waveguides is designed as a CFB comprising a single-mode optical waveguide.

In embodiments of the method, the arrangement of electromagnetic waveguides is designed as a multi-core fiber comprising 100 to 100,000 single-mode cores.

In embodiments of the method, the compensation of phase distortion and/or the implementation of a function which changes the propagation directions of electromagnetic radiation upon entrance into and/or exit from the arrangement is carried out by a static element which is either a transmissive or a reflective element and/or by an adaptive element which is either a transmissive or a reflective element, wherein a reflective element is positioned at a distance from the corresponding end of the arrangement behind which it is positioned, and images a phase mask onto the corresponding end of the arrangement by reflecting electromagnetic radiation of the at least two wavelengths from a suitable angle of incidence.

An adaptive element is expediently designed as a spatial light modulator, wherein the spatial light modulator is an electro-optically modulated spatial light modulator, or a thermo-optically modulated spatial light modulator. Advantageously, the spatial light modulator is designed as an LCoS.

The distance of the reflective element from the corresponding end of the arrangement behind which it is positioned can be chosen as desired.

In embodiments, the distance is within the range between 10,000 times the smallest of the wavelengths and 10,000,000 times the largest of the wavelengths.

In embodiments, the distance is within the range between 10,000 times the smallest of the wavelengths and 100,000 times the largest of the wavelengths.

The suitable angle of incidence of electromagnetic radiation on the reflective element is above 0° and below 90°.

In embodiments, the angle of incidence of electromagnetic radiation on the reflective element is between 10° and 80°.

In embodiments of the method:
the lengthening of selected waveguides to compensate for phase distortions and/or to implement a function which changes the propagation directions of electromagnetic radiation upon entrance into and/or exit from the arrangement is effected by additive manufacturing on the selected waveguides at the first end and/or at the second end of the arrangement, and/or
the shortening of selected waveguides to compensate for the phase distortion and/or to implement a function which changes the propagation directions of electromagnetic radiation upon entrance into and/or exit from the arrangement is effected by laser ablation and/or by electron beam ablation of the selected waveguides at the first end and/or the second end of the arrangement, and/or
the provision of the element at the first end and/or at the second end of the arrangement is effected by additive manufacturing on an element blank and/or by laser ablation and/or by electron beam ablation of an element blank, and/or
the provision of the element at the first end and/or the second end of the corresponding waveguide is effected by manufacturing metaoptics, wherein the metaoptics have structures whose dimensions are smaller than the smallest of the wavelengths.

In the context of the invention, an element blank is the element in the state in which it is prior to additive manufacturing and/or laser ablation and/or electron beam ablation, by means of which it is made into an element for compensating for phase distortions of at least two wavelengths of an arrangement of electromagnetic waveguides and/or for implementing a function which determines the propagation directions of electromagnetic radiation upon entrance into and/or exit from the arrangement.

In embodiments of the method, additive manufacturing comprises one-photon polymerization and/or two-photon polymerization and/or multi-photon polymerization.

In embodiments of the method, sub-step b) i) of the method according to the invention is carried out either by means of white light interferometry or by means of digital holography and/or a phase retrieval method.

Digital holography and the phase retrieval method can be used together.

In further embodiments, the digital holography is designed as off-axis holography using a Mach-Zehnder interferometer.

A further aspect of the invention relates to a device for compensating for electromagnetic phase distortions of at least two wavelengths of an arrangement of electromagnetic waveguides j and/or for implementing a function which changes the propagation directions of electromagnetic radiation upon entrance into and/or exit from the arrangement, comprising an arrangement of at least two electromagnetic waveguides, characterized in that
the device comprises an element for compensating for phase distortions and/or for implementing a function which changes the propagation directions of electromagnetic radiation upon entrance into and/or exit from the arrangement and/or is modulated at a first end and/or a second end of the arrangement such that the element has a correcting variable x_{j_ƒmin} along the electromagnetic propagation direction of one or more selected waveguides, and/or
the device is modulated in that the arrangement comprises a shortening and/or lengthening of the selected waveguides, wherein for each of the selected waveguides the shortening and/or lengthening has a correcting variable x_{j_ƒmin}
wherein the correcting variable x_{j_ƒmin} is determined by sub-steps b) i) to v) of the method according to the invention.

The phase distortion φ_{actual} of a waveguide of the arrangement with subscript j at one wavelength λ can be calculated using the formula

$${φ}_{actual} ( λ , j ) = 2 π ( \frac{Δ L ( λ , j )}{λ} mod 1 ) ,$$

wherein ΔL is a deviation of an electromagnetic path length of the waveguide j at the wavelength λ from the average electromagnetic path length at the wavelength λ of all waveguides. The electromagnetic path length of the waveguide is the length of the path that electromagnetic radiation would travel in a vacuum in the same time that it takes to traverse the waveguide in its rest frame.

Other descriptions of phase distortion φ_{actual} are not excluded. In an alternative embodiment, a reference path length can be used instead of ΔL—which is the deviation of the electromagnetic path length of a waveguide from an arbitrary reference length.

The desired modulated phase φ_{desired} can be set for each of the wavelengths independently or depending on the desired modulated phase φ_{desired} for one or more of the other wavelengths, thus making it possible to implement different functions for different wavelengths. This means that for electromagnetic radiation of a first wavelength, a bundling of the radiation to a focal point is desired, while for radiation of a second wavelength a doughnut mode is desired, and for radiation of a third wavelength a tilting of the propagation direction is desired. Combinations of such functions, such as tilting the propagation direction and focusing the radiation of one wavelength on a focal point, are also possible. It is also possible that φ_{desired} is selected for different wavelengths such that the propagation direction of the radiation is tilted by a different angle for each of the different wavelengths and/or is bundled at a different focal point for each of the different wavelengths. Examples of such functions are the focusing of the radiation to a focal point in a plane, similar to what is possible with a convex lens, the tilting of the radiation, or the generation of a doughnut mode, i.e. a ring-shaped distribution of the intensity of electromagnetic radiation in a plane.

In embodiments of the device, the desired modulated phase φ_{desired} can be described by the formula φ_{desired}(λ,j)=(φ_{actual}(λ,j)+φ_{shift}(λ,j))mod (2π), wherein φ_{shift}(λ,j) is a desired phase shift.

A change in the electromagnetic path length which results in the desired modulated phase φ_{desired} can be calculated using the formula

$${L}_{desired} ( λ , j ) = \frac{{λφ}_{shift} ( λ , j )}{2 π} + N λ$$

where N is any integer.

In further embodiments of the device, N lies in the region between and including −9 and +9

In embodiments of the device designed to compensate for the phase distortion φᵢₛₜ for one wavelength λ and one waveguide j and also to implement an additional function φ_{add} the desired phase shift φ_{shift}(λ,j) can be calculated by the formula

$${φ}_{shift} ( λ , j ) = ( - {φ}_{actual} ( λ , j ) + {φ}_{add} ( λ , j ) ) mod ( 2 π )$$

In further embodiments of the device designed to compensate for the phase distortion φ_{actual} for one wavelength λ and one waveguide j without implementing an additional function, the additional function φ_{add}(λ,j)=0 can be used, such that the desired phase shift is determined by the formula φ_{shift}(λ,j)=(−φ_{actual}(λ,j))mod (2π), and the phase distortion φ_{actual} is fully compensated for.

Since the correcting variable xⱼ in general cannot be varied for each wavelength individually, it is generally not possible to achieve the ideal state φ_{desired}=φᵣₑₛ for each wavelength and for each waveguide, which is why it is necessary to minimize the error function ƒ to get as close to the ideal state as possible.

In embodiments of the device, the correcting variable xⱼ has a functional relationship with
a) a path length difference ΔSⱼ and/or
b) a voltage Uⱼ and/or
c) an electrical current Iⱼ and/or
d) a current pulse width Pᵢⱼ and/or
e) a voltage pulse width P_{Uj} and/or
f) a temperature Tⱼ and/or
g) an SLM grayscale value.

The correcting variable xⱼ can be adjusted by means of different methods.

In embodiments, if it is adjusted by means of a shortening and/or lengthening of the selected waveguides, the correcting variable xⱼ has a functional relationship with a path length difference ΔSⱼ caused by shortening and/or lengthening. The correcting variable xⱼ also has a functional relationship with a path length difference ΔSⱼ when it is adjusted by means of an additive or ablative manufacturing of a transmissive element.

In further embodiments, if the correcting variable xⱼ is adjusted by means of a spatial light modulator, it can have a functional relationship with one or more physical quantities with which the spatial light modulator is controlled. This quantity or quantities can be a voltage Uⱼ and/or an electrical current Iⱼ and/or a current pulse width Pᵢⱼ and/or a voltage pulse width P_{Uj} and/or a temperature Tⱼ. This quantity or quantities can also have a functional relationship with a path length difference ΔSⱼ. This is the case, for example, if a spatial light modulator has an arrangement of micromirrors that can be separately controlled, lowered, raised and/or tilted.

The correcting variable xⱼ can be controlled by current or voltage pulse width modulation in embodiments with spatial light modulators.

The correcting variable xⱼ can be controlled in further embodiments with spatial light modulators by means of temperature modulation, wherein the temperature is functionally related to a current and/or a voltage. Thermo-optically modulated spatial light modulators, for example, can be controlled by temperature, which in turn can be controlled by an electrical current.

The phase change φ_{corr} of a waveguide of the arrangement with subscript j at one wavelength Δ can be calculated using the formula

$${φ}_{corr} ( λ , j ) = \frac{{x}_{j} ( n ( λ , j ) - {n}_{U} ( λ ) )}{λ} mod ( 2 π ) ,$$

where n(λ,j) is the refractive index of the waveguide j at the wavelength Δ for the material for which the correcting variable xⱼ is applied, and n_{U}(λ) is the refractive index of the medium surrounding the arrangement at the wavelength λ.

Other descriptions of the phase change φₛₜₑₗₗ are not excluded.

In general, different values of the correcting variable xⱼ can have the same phase change φ_{corr} for one wavelength. This principle makes use of the device according to the invention to determine a value of the correcting variable xⱼ at which the resulting phase φᵣₑₛ=(φ_{actual}+φ_{desired})mod(2π) corresponds to the desired modulated phase φ_{desired} for all of the wavelengths as closely as possible. Surprisingly, this is the case with values of the correcting variable xⱼ for which the phase change φ_{corr} would lie far beyond 2π if it did not comprise the modulo-operator mod(2π).

In embodiments of the device, the at least two wavelengths are in a wavelength range between 100 nm and 1,000,000 nm, advantageously in a wavelength range from 100 nm to 3,000 nm, particularly advantageously in the range 350 nm to 1,550 nm and/or are selected from the wavelengths 450 nm, 520 nm, 530 nm, 638 nm, 920 nm, 1,330 nm and 1,550 nm.

In embodiments, the at least two wavelengths lie in a range of the electromagnetic spectrum ranging from UV-C to FIR radiation.

In embodiments, the at least two wavelengths are in a region of the electromagnetic spectrum ranging from UV-C to IR-B radiation.

In embodiments, the at least two wavelengths are in a range of the electromagnetic spectrum ranging from and including UV-C through the range of IR-A radiation to the shortest-wavelength

$$\frac{3}{32} nd$$

of IR-B radiation.

In embodiments of the device, the arrangement of electromagnetic waveguides is designed as an image waveguide and/or as a bundle of optical fibers comprising at least two optical waveguides and/or as a bundle of optical fibers comprising 100 to 100,000 optical waveguides.

The arrangement of electromagnetic waveguides comprised by the device is designed in embodiments as a bundle of single-mode optical waveguides.

In embodiments, the arrangement of electromagnetic waveguides is designed as a CFB comprising a single-mode optical waveguide.

In further embodiments of the method, the arrangement of electromagnetic waveguides is designed as a multi-core fiber comprising 100 to 100,000 single-mode cores.

In embodiments of the device comprising an element, the element is a static element which is either a transmissive or a reflective element and/or an adaptive element which is either a transmissive or a reflective element, wherein a reflective element is positioned at a distance from the corresponding end of the arrangement behind which it is positioned, and images a phase mask onto the corresponding end of the arrangement by reflecting electromagnetic radiation of the at least two wavelengths from a suitable angle of incidence, wherein the adaptive element is designed as a spatial light modulator.

An adaptive element is expediently designed as a spatial light modulator, wherein the spatial light modulator is an electro-optically modulated spatial light modulator, or a thermo-optically modulated spatial light modulator. Advantageously, the spatial light modulator is designed as an LCoS.

The distance of the reflective element from the corresponding end of the arrangement behind which it is positioned can be chosen as desired.

In embodiments, the distance is within the range between 10,000 times the smallest of the wavelengths and 10,000,000 times the largest of the wavelengths.

In embodiments, the distance is within the range between 10,000 times the smallest of the wavelengths and 100,000 times the largest of the wavelengths.

The suitable angle of incidence of electromagnetic radiation on the reflective element is above 0° and below 90°.

In embodiments, the angle of incidence of electromagnetic radiation on the reflective element is between 10° and 80°.

In embodiments of the device comprising an element, the element is a static element, the element having a path length difference ΔSⱼ along the electromagnetic propagation direction of each of the selected waveguides, with respect to a reference length.

The reference length in this case can be any given reference length. The path length difference ΔSⱼ for each of the selected waveguides is realized by surface properties of the element designed as a phase mask.

In embodiments of the device, the material of the element for compensating for the phase distortion of the selected waveguides at the first end and/or at the second end of the corresponding waveguide comprises metaoptics, wherein the metaoptics are characterized in that they have structures whose dimensions are smaller than the smallest of the wavelengths.

In principle, metaoptics can be provided which have structures characterized by the fact that the functional relationship between their refractive indices and the wavelength of electromagnetic radiation can be freely selected. Unlike conventional materials that are transparent to electromagnetic radiation, this functional relationship cannot necessarily be represented by the Sellmeier equation. With freely selectable refractive indices, it is possible to determine the resulting phase φᵣₑₛ for each of the wavelengths with the desired modulated phase φ_{desired} and thus completely cancel out the phase distortion for each of the wavelengths.

A further aspect of the invention relates to the use of
the method according to the invention and/or its embodiments and/or of
the device according to the invention and/or its embodiments
in microscopy, STED microscopy, confocal fluorescence microscopy, confocal imaging, nonlinear imaging, confocal autofluorescence microscopy, optical coherence tomography, spectroscopy, multispectral imaging, structured illumination, optogenetics, laser ablation, optical trapping, needle biopsy and/or in endoscopy, multispectral endoscopy and/or STED endoscopy.

The invention is not limited to the illustrated and described embodiments, but also includes all embodiments which act identically within the meaning of the invention. Furthermore, the invention is also not limited to the specifically described feature combinations, but may also be defined by any other combination of particular features of all individual features disclosed overall, provided the individual features are not mutually exclusive, or a specific combination of individual features is not explicitly excluded.

### Exemplary Embodiment

The invention is to be explained in more detail below on the basis of an embodiment. The exemplary embodiment relates to an embodiment of the method and the device according to the invention, and is intended to describe the invention without limiting it.

An endoscope is provided which includes a Sumita HDIG 10,000 fiber cores single-mode CFB. The diameter of the endoscope is 385 μm and is only limited by the CFB.

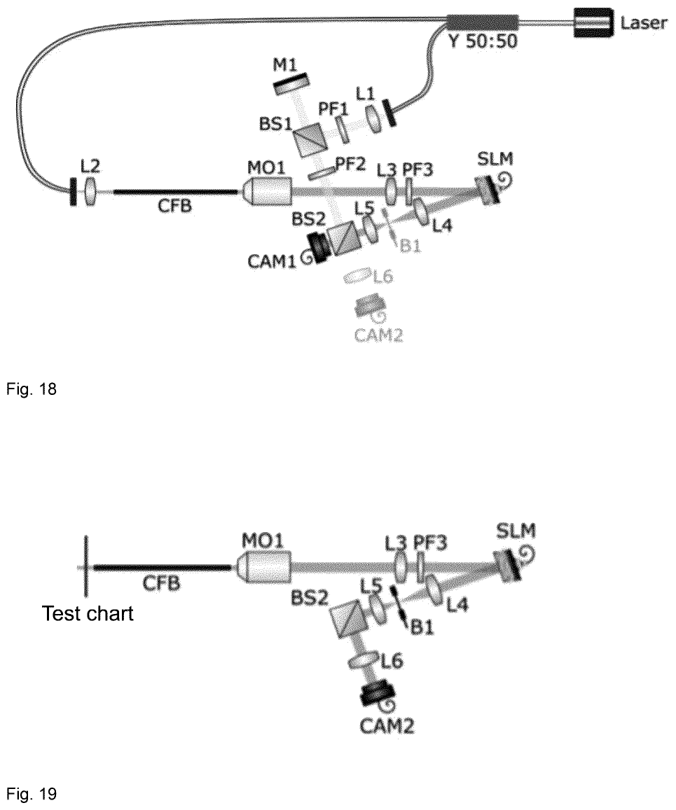

FIG. 18 shows a schematic setup for determining and compensating for the phase distortion of a CFB. The phase distortion φᵢₛₜ of each fiber core of the single-mode CFB is measured sequentially in the wavelengths 450 nm, 520 nm and 638 nm by means of off-axis holography using a Mach-Zehnder interferometer, the structure comprising components known to the person skilled in the art—namely a laser, an aperture (B1), beam splitters (BS1 and BS2), lenses (L1, L2, L3, L4, L5 and L6), a mirror (M1), a microscope objective (MO1), polarization filters (PF1, PF2 and PF3) and a fiber-coupled beam splitter (Y 50:50), which splits radiation into two components in an intensity ratio of 50:50. For this purpose, the proximal end of the single-mode CFB is imaged on a camera (CAM1). Light from the proximal end of the multicore fiber strikes a reflective spatial light modulator (SLM) of the Holoeye Pluto-NIR-011 in the switched-off state, and is reflected by it in the direction of the camera (CAM1). The proximal end of the CFB and the spatial light modulator (SLM) are sharply imaged by the camera (CAM1). As an alternative to the switched-off state, the spatial light modulator can also be in the switched-on state, but have the same grayscale value for all fiber cores.

For each fiber core of the CFB, all grayscale values of the spatial light modulator (SLM) from 0 to 255 are set sequentially. For each fiber core, the resulting phase φᵣₑₛ is measured in each of the three wavelengths at each grayscale value, and each measured value is saved. Also, for each fiber core and each grayscale value of the spatial light modulator (SLM), the sum of the squares of the resulting phase φᵣₑₛ is determined across all three wavelengths and stored. The square root of the sum of the squares of the resulting phase φᵣₑₛ over all three wavelengths is the error function ƒ.

The phase distortion is compensated for by setting the grayscale value of the spatial light modulator SLM for each fiber core of the CFB on the spatial light modulator SLM at which the error function ƒ assumes the lowest value.

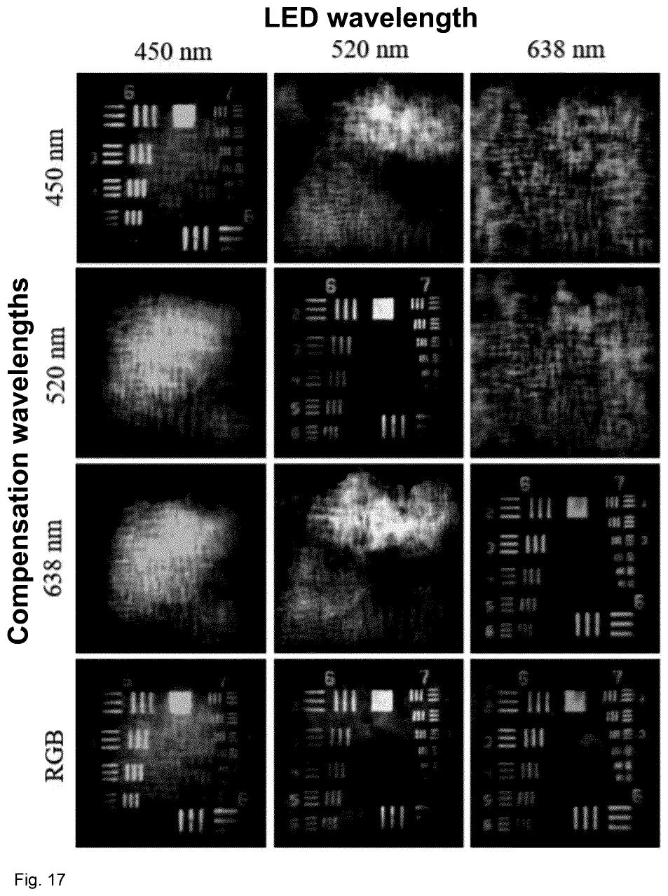

FIG. 19 schematically shows a setup for imaging a USAF resolution test panel illuminated with an RGB LED (red-green-blue light-emitting diode) emitting at wavelengths of 450 nm, 520 nm and 638 nm onto a camera (CAM2) with the same CFB and the SLM previously adjusted to compensate for the phase distortion. The USAF resolution test chart is sharply imaged by the camera (CAM2). The image of the USAF resolution test chart in the three wavelengths is shown in the fourth row of FIG. 17.

### REFERENCE SIGNS

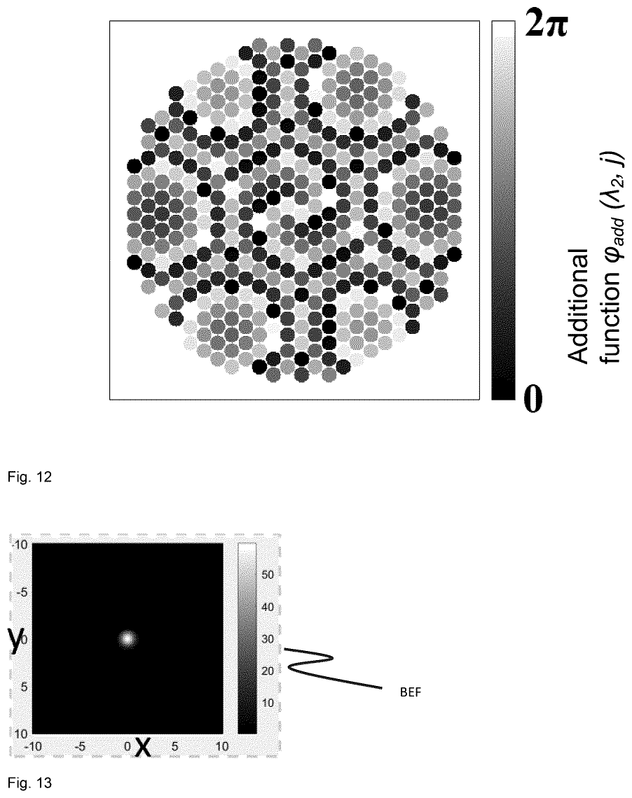

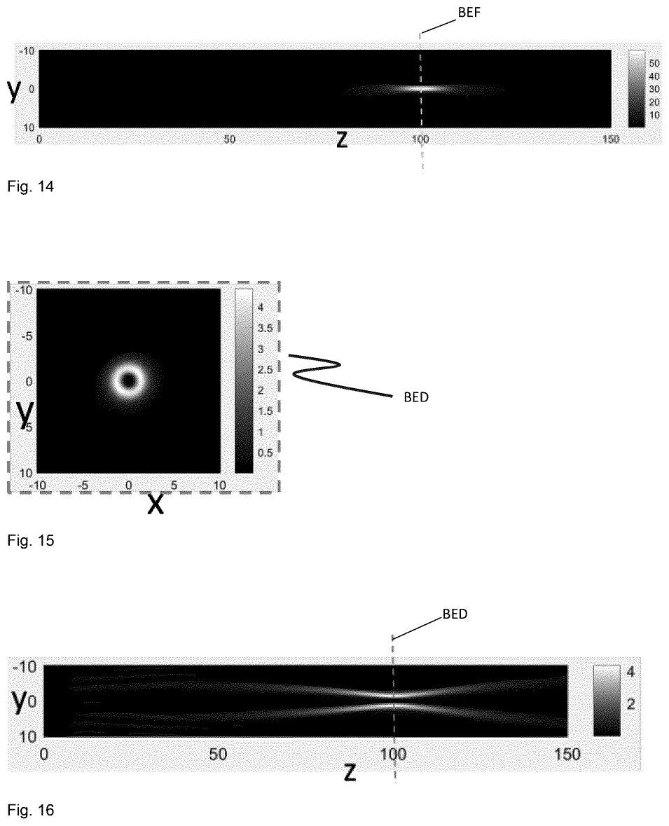

1 Incoming electromagnetic radiation without phase distortion
2 Arrangement of electromagnetic waveguides
3 Electromagnetic waveguides
4 Emerging electromagnetic radiation exhibiting a phase distortion
5 Resulting phase φ_{res-red} for λ=638 nm as a function of the SLM gray value
6 Resulting phase φ_{res-green} for λ=520 nm as a function of the SLM gray value
7 Resulting phase φ_{res-blue} for λ=450 nm as a function of the SLM gray value
8 Error function ƒ in a case where φ_{desired}=0: ƒ=Σᵢ₌₁³φᵣₑₛ_{ᵢ}²
9 An additively manufactured phase mask element for compensating for the phase distortion and implementing a function which focuses the propagation directions of electromagnetic radiation onto a focal point when exiting the arrangement
10 Emerging electromagnetic radiation with compensated phase distortion, and which is focused onto a focal point
11 An additively manufactured phase mask element for compensating for the phase distortion
12 Emerging electromagnetic radiation with compensated phase distortion
13 Radiation reflected by the spatial light modulator with a phase shift φ_{shift}(λ,j)=((−φ_{actual}(λ,j))+φ_{add}(λ,j))mod (2π) compensating for the phase distortion of the electromagnetic waveguide, and implementing an additional function that results in focusing onto a focal point
BEF Focal plane shown in FIG. 12
BED Focal plane of the doughnut mode shown in FIG. 14
B1 Aperture
BS1, BS2 Beam splitter
CAM1, Camera
CAM2
CFB Coherent bundle of optical fibers
L1, L2, Lens
L3, L4,
L5, L6
M1 Mirror
MO1 Microscope lens
PF1, Polarizing filter
PF2, PF3
Test panel USAF resolution test panel
SLM Spatial light modulator
Y 50:50 Fiber-coupled beam splitter

1. A method for compensating for phase distortions of at least two wavelengths in an arrangement of electromagnetic waveguides j and/or for implementing a function which changes the propagation directions of electromagnetic radiation upon entrance into and/or exit from the arrangement, comprising the steps of:
a. providing an arrangement of electromagnetic waveguides j, wherein the arrangement comprises at least two electromagnetic waveguides j,
b. modulating the electromagnetic phase distortion φ_{actual} of one or more selected waveguides j of the arrangement, said distortion having a functional relationship with a reference path length of one or more selected waveguides, for each of the wavelengths, comprising the sub-steps of:
i) measuring the electromagnetic phase distortion φ_{actual} for each of the wavelengths in each of the selected waveguides j,
ii) determining a desired modulated phase φ_{desired} for each of the selected waveguides j and for each of the wavelengths, wherein the desired modulated phase φ_{desired} for each of the wavelengths is determined independently or depending on φ_{desired} for one or more of the other wavelengths
iii) determining a functional relationship between a correcting variable xⱼ and a phase change φ_{corr} for each of the wavelengths and for each of the selected waveguides j
iv) defining an error function ƒ to describe the total deviation between a resulting phase φᵣₑₛ=(φ_{actual}+φ_{corr})mod(2π) and the desired modulated phase φ_{desired} over all wavelengths for each of the selected waveguides j,
v) determining the value x_{j_ƒmin} in of the correcting variable xⱼ for which the error function ƒ assumes a minimum value for each of the selected waveguides j.
vi)
1. providing and positioning an element for compensating for phase distortions of at least two wavelengths of an arrangement of electromagnetic waveguides and/or for implementing a function which changes propagation directions of electromagnetic radiation upon entrance into and/or exit from the arrangement, behind a first end and/or behind a second end of the arrangement, such that the element has the value x_{j_ƒmin} of the correcting variable xⱼ along the electromagnetic propagation direction of each of the selected waveguides,
and/or
2. shortening and/or lengthening the selected waveguides to compensate for the phase distortion of the selected waveguides and/or to implement a function which changes the propagation directions of electromagnetic radiation upon entrance into and/or exit from the arrangement, at the first end and/or at the second end of the arrangement, such that the shortening and/or lengthening for each of the selected waveguides and each of the wavelengths has the value x_{j_ƒmin} of the correcting variable xⱼ,
such that the arrangement of electromagnetic waveguides comprising the element and/or the shortening and/or lengthening of the selected waveguides has a resulting phase φ_{res_ƒmin} for each of the wavelengths and each of the selected waveguides, wherein the error function ƒ assumes a minimum value.

2. The method according to claim 1, wherein the error function ƒ is determined for each of the selected waveguides
by taking a square root of the squares, summed over all of the wavelengths, of the deviation between the resulting phase φᵣₑₛ and the desired modulated phase φ_{desired} or
by summing, over all the wavelengths, the absolute values of the deviation between the resulting phase φᵣₑₛ and the desired modulated phase φ_{desired}.

3. The method according to claim 1, wherein the resulting value of the correcting variable x_{j_ƒmin} for each of the selected waveguides is determined by an iterative method, such that the iterative method minimizes the error function ƒ.

4. The method according to claim 3, comprising:
a) measuring, in a plane behind the first end or behind the second end of the arrangement or of the arrangement comprising the element, the intensity of electromagnetic radiation guided through each of the selected waveguides in each of the wavelengths,
b) determining the difference between the measured intensity and the expected intensity for the desired modulated phase φ_{desired}, for each of the wavelengths and each of the selected waveguides,
c) changing the value of the correcting variable xⱼ for each of the selected waveguides,
d) carrying out steps a), b) and c) until a local minimum or the global minimum of the difference between the measured intensity and the expected intensity with the desired modulated phase φ_{desired} is determined, and setting the correcting variable xⱼ to the value at which the determined local minimum or global minimum is reached, for each of the selected waveguides.

5. The method according to claim 1, wherein the correcting variable xⱼ has a functional relationship with
a) a path length difference ΔSⱼ and/or
b) a voltage Uⱼ and/or
c) an electrical current Iⱼ and/or
d) a current pulse width Pᵢⱼ and/or
e) a voltage pulse width P_{Uj} and/or
f) a temperature Tⱼ and/or
g) an SLM grayscale value.

6. The method according to claim 5, wherein the functional relationships between the correcting variable xⱼ and the quantities named in a) to f) are each determined by a calibration, and/or the functional relationship between the correcting variable xⱼ and the path length change ΔS comprises the difference—normalized in each for the corresponding wavelength—between
a) the refractive index of the lengthened and/or shortened waveguides and/or the element, and
b) the refractive index of the medium surrounding the arrangement.

7. The method according to claim 1, wherein the at least two wavelengths are in a wavelength range from 100 nm to 1,000,000 nm.

8. The method according to claim 1, wherein the arrangement of electromagnetic waveguides is designed as an image waveguide and/or as a bundle of optical fibers comprising at least two optical waveguides and/or as a bundle of optical fibers comprising 100 to 100,000 optical waveguides.

9. The method according to claim 1, wherein the compensation of phase distortion and/or the implementation of a function which changes the propagation directions of electromagnetic radiation upon entrance into and/or exit from the arrangement is carried out by a static element which is either a transmissive or a reflective element and/or by an adaptive element which is either a transmissive or a reflective element, wherein a reflective element is positioned at a distance from the corresponding end of the arrangement behind which it is positioned, and images a phase mask onto the corresponding end of the arrangement by reflecting electromagnetic radiation of the at least two wavelengths from a suitable angle of incidence, wherein the adaptive element is designed as a spatial light modulator.

10. The method according to claim 1, wherein
the lengthening of selected waveguides to compensate for phase distortions and/or to implement a function which changes the propagation directions of electromagnetic radiation upon entrance into and/or exit from the arrangement is effected by additive manufacturing on the selected waveguides at the first end and/or at the second end of the arrangement, and/or in that
the shortening of selected waveguides to compensate for the phase distortion and/or to implement a function which changes the propagation directions of electromagnetic radiation upon entrance into and/or exit from the arrangement is effected by laser ablation and/or by electron beam ablation of the selected waveguides at the first end and/or the second end of the arrangement, and/or in that
the provision of the element at the first end and/or at the second end of the arrangement is effected by additive manufacturing on an element blank and/or by laser ablation and/or by electron beam ablation of an element blank, and/or
the provision of the element at the first end and/or the second end of the corresponding waveguide is effected by manufacturing metaoptics, wherein the metaoptics have structures with diameters which are smaller than the smallest of the wavelengths.

11. The method according to claim 10, wherein the additive manufacturing comprises one-photon polymerization and/or two-photon polymerization and/or multi-photon polymerization.

12. The method according to claim 1, wherein sub-step b) i) is carried out either by means of white light interferometry or by means of digital holography and/or a phase retrieval method.

13. A device for compensating for electromagnetic phase distortions of at least two wavelengths of an arrangement of electromagnetic waveguides j and/or for implementing a function which changes the propagation directions of electromagnetic radiation upon entrance into and/or exit from the arrangement, comprising an arrangement of at least two electromagnetic waveguides, wherein
the device comprises an element for compensating for phase distortions and/or for implementing a function which changes the propagation directions of electromagnetic radiation upon entrance into and/or exit from the arrangement and/or is modulated at a first end and/or a second end of the arrangement such that the element has a correcting variable x_{j_ƒmin} along the electromagnetic propagation direction of one or more selected waveguides, and/or
the device is modulated in that the arrangement comprises a shortening and/or lengthening of the selected waveguides, wherein for each of the selected waveguides the shortening and/or lengthening has a correcting variable x_{j_ƒmin},
wherein the correcting variable x_{j_ƒmin} is determined by sub-steps b) i) to v) of the method according to claim 1.

14. The device according to claim 13, wherein the correcting variable xⱼ has a functional relationship with
a) a path length difference ΔS₁ and/or
b) a voltage Uⱼ and/or
c) an electrical current Iⱼ and/or
d) a current pulse width Pᵢⱼ and/or
e) a voltage pulse width P_{Uj} and/or
f) a temperature Tⱼ and/or
g) an SLM grayscale value.

15. The device according to claim 13, wherein the at least two wavelengths are in a wavelength range between 100 nm and 1,000,000 nm.

16. The device according to claim 13, wherein the arrangement of electromagnetic waveguides is designed as an image waveguide and/or as a bundle of waveguides comprising at least two optical fibers and/or as a bundle of 100 to 100,000 optical fibers.

17. The device according to claim 13, wherein the element is a static element which is either a transmissive or a reflective element and/or an adaptive element which is either a transmissive or a reflective element, wherein a reflective element is positioned at a distance from the corresponding end of the arrangement behind which it is positioned, and images a phase mask onto the corresponding end of the arrangement by reflecting electromagnetic radiation of the at least two wavelengths from a suitable angle of incidence, wherein the adaptive element is designed as a spatial light modulator.

18. The device according to claim 13, wherein the element is a static element, wherein the element has a path length change ΔSⱼ with respect to a reference path length along the electromagnetic propagation direction of each of the selected waveguides.

19. The device according claim 13, wherein the material of the element for compensating for the phase distortion of the selected waveguides at the first end and/or at the second end of the corresponding waveguide comprises metaoptics, wherein the metaoptics comprise structures with diameters which are smaller than the smallest of the wavelengths.

20. The method according to claim 1, wherein the at least two wavelengths are in a wavelength range from 350 nm to 1,550 nm.
